(19) United States
(12) Patent Application Publication
(10) Pub. No.: US 2023/0160546 A1
(43) Pub. Date: May 25, 2023

(54) ILLUMINATION SYSTEM

(71) Applicant: ANTARES ILUMINACIÓN, S.A.U, Valencia (ES)

(72) Inventor: Federico MARTINEZ WEBER, Valencia (ES)

(21) Appl. No.: 17/916,976

(22) PCT Filed: Apr. 7, 2020
(86) PCT No.: PCT/ES2020/070230

§ 371 Date: Oct. 4, 2022

(51) Int. Cl. F21S 2/00; F21S 4/28; F21V 23/06; F21V 17/10

(52) U.S. Cl. CPC F21S 2/005; F21S 4/28; F21V 23/06; F21V 17/101; F21V 17/105

(57) ABSTRACT

The present invention is related to an illumination system that enables installation conditions to be simplified, such that the gap area of the wall, ceiling or floor wherein said illumination system is integrated is minimised, in addition to facilitating the insertion of the electrical contacts of the functional unit and enabling the concealment thereof to be carded out without modifying the conductive properties thereof, minimising all the functional elements arranged inside the gap of the wall ceiling or floor.

### OBJECT OF THE INVENTION

The present invention is related to an illumination system that enables installation conditions to be simplified, such that the gap area of the wall, ceiling or floor wherein said illumination system is integrated is minimised.

The object of the present invention is an illumination system that facilitates the insertion of the electrical contacts of the functional unit and enables the concealment thereof to be carried out without modifying the conductive properties thereof, minimising all the functional elements arranged inside the gap of the wall, ceiling or floor.

### BACKGROUND OF THE INVENTION

In the state of the art, illumination systems are known that enable illumination devices to be integrated in wall, ceiling or floor gaps.

These systems comprise a support structure that extends in a longitudinal direction and that forms an internal space, accessible from an opening, at least one functional unit that can be housed in the internal space of the support structure, provided with a lower surface wherein electrical contacts and at least one illumination device provided with illumination means and comprising electrical contacts that can be coupled to the electrical contacts of the functional unit to keep the illumination device connected to the functional unit are embodied.

The above systems have the drawback that it is necessary to arrange the functional unit within a support profile that subsequently must be vertically inserted into a support structure to couple the functional unit within the support structure.

In the previous systems, it is also not possible to insert the functional unit in the longitudinal direction of the support structure due to the structure thereof.

Document EP2657590A1 from this same applicant is known, relating to an illumination device comprising:
a support structure extending in a longitudinal direction and forming an internal space;
at least one functional unit extending in a longitudinal direction which can be housed in the internal space of the support structure, provided with a lower surface comprising electrical contacts;
at least one illumination device provided with illumination means and comprising electrical contacts that can be coupled to the electrical contacts of the functional unit to keep the illumination device connected to the functional unit.

In the previous document, the functional unit must be housed in the longitudinal direction with the electrical contacts arranged on the lower surface of said functional unit. In this way, the width of the support structure can never be less than the width of the functional unit, such that the gap of the wall, ceiling or floor where the illumination device is arranged is always imposed by the width of the functional unit and the consequent electrical board associated with the electrical contacts and the electronic board that controls the illumination device.

The present invention solves all the previous drawbacks, facilitating the insertion of the electrical contacts of the functional unit and enabling the concealment thereof to be carried out without modifying the conductive properties thereof, minimising all the functional elements arranged inside the gap of the wall, ceiling or floor.

### DESCRIPTION OF THE INVENTION

The present invention is related to an illumination system that can be coupled to the ceiling, a wall or the floor of a room where it is arranged.

The illumination system comprises an illumination device that can be moved from a position where it is fully or partially housed inside a support structure to a position where it is partially housed or fully protruding from the support structure, respectively.

The illumination system comprises:
a support structure extending in a longitudinal direction and forming an internal space accessible from an opening of said support structure, wherein the support structure comprises two facing side walls and a rear wall connecting the two facing side walls and closing the internal space at the rear portion thereof,
at least one functional unit extending in the longitudinal direction which can be housed in the internal space of the support structure, wherein the functional unit comprises at least one electrical contact;
at least one illumination device provided with illumination means and comprising electrical contacts that can be coupled to the at least one electrical contact of the functional unit to keep the illumination device connected to the functional unit, wherein the at least one electrical contact of the functional unit is integrated in at least one of the two side walls of the support structure and it is intended to face the electrical contacts of the illumination device.

Preferably, the functional unit is integrated in at least one of the two side walls of the support structure.

In this way, the gap area of the wall, ceiling or floor wherein said illumination system is integrated is minimised, since all the functional elements arranged inside the gap of the wall, ceiling or floor are minimised, while facilitating the insertion of the electrical contacts of the functional unit and enabling the concealment thereof to be carried out without modifying the conductive properties thereof.

Preferably, the at least one functional unit comprises a plate of conductive material, preferably Cu, comprising an outer surface wherein the at least one electrical contact is arranged in the form of a darkened conductive coating, preferably copper oxide (II), CuO, with great resistance to abrasion and high electrical conductivity, wherein the darkened aspect conferred by the conductive coating hinders the perception thereof by an observer or user.

Optionally, the at least one functional unit comprising the electrical contact is attached to the support structure by means of attachment means, preferably an adhesive.

Optionally, the illumination system further comprises insulation means arranged between the support structure and the at least one functional unit comprising the electrical contact.

Furthermore, the illumination device comprises magnetic means adapted to magnetically couple with magnetic means of the support structure in order to keep the illumination device attached to said support structure and consequently to said functional unit.

The illumination devices can be moved along the longitudinal direction of the functional unit, since the electrical contacts of each illumination device are kept in contact with the at least one electrical contact of the functional unit.

The functional unit comprises an electrical connector that can be connected to a power cable for the electrical connection of several functional units, to control means of LED modules.

Optionally, the illumination device can be fully housed inside the support structure, partially or fully protrude therefrom, be telescopic such that it can be moved from a position where it is fully or partially housed inside the support structure to a position where it is partially housed or fully protruding from the support structure, respectively, or it can be folded.

### BRIEF DESCRIPTION OF THE DRAWINGS

FIG. 1 shows a cross-sectional view of a first exemplary embodiment of the support structure of the power system of the present invention.

FIG. 2 shows a perspective view of a second exemplary embodiment of the support structure of the power system of the present invention.

FIG. 3 shows a detail A of FIGS. 1 and 2.

FIG. 4 shows a perspective view of the illumination device according to a first exemplary embodiment of the illumination system of the present invention.

FIG. 5 shows an elevation view of FIG. 4.

FIG. 6 shows an elevation view of the illumination device according to a second exemplary embodiment of the illumination system of the present invention.

FIG. 7 shows a side view of FIG. 6.

FIG. 8 shows a cross-sectional detail of FIG. 7 wherein the distribution of the light rays emitted by the at least one light source as it passes through the lens of the illumination device has been represented.

FIG. 9 shows the angular distribution of light intensity of the illumination device of FIG. 6 both in the horizontal plane, in the centre, and in the vertical plane, on the right.

FIG. 10 shows an elevation view of the illumination device according to a third exemplary embodiment of the illumination system of the present invention.

FIG. 11 shows a side view of FIG. 10.

### PREFERRED EMBODIMENT OF THE INVENTION

The illumination system of the present invention will be described below.

The illumination system comprises an illumination device (6, 7, 8) that can be fully housed inside a support structure (10, 100), partially or fully protrude therefrom (10, 100) or be telescopic, such that it can be moved from a position where it is fully or partially housed inside the support structure (10, 100) to a position where it is partially housed or fully protruding from the support structure (10, 100), respectively.

The support structure (10, 100) of the illumination system is preferably extruded, for example of aluminium, extending in a longitudinal direction (X) and forming an internal space (12), accessible from an opening (4) of said support structure (10, 100).

Preferably, the support structure (10, 100) has an inverted U shape and comprises two facing side walls (14) that define two internal side surfaces (16), preferably flat and parallel, and a rear wall (18), connecting the two facing side walls (14) and closing the internal space (12) at the upper portion.

The system further comprises a functional unit (40) that can be coupled to the support structure (10, 100), which is fully arranged in the internal space (12) of said support structure (10, 100) by means of the longitudinal displacement of said functional unit (40) through at least one side groove (43) present in at least one of the two internal side surfaces (16) of the two side walls (14) of the support structure (10, 100). Preferably, said functional unit (40) has a plate form, which, due to its arrangement in the side groove (43) of the at least one of the two side surfaces (16), does not take up space in the free space of the support structure (10, 100), which enables the illumination device (6, 7, 8), or at least the portion of said illumination device (6, 7, 8) that is arranged inside said support structure (10, 100) to have reduced width dimensions, or in other words, the separation between the two side walls (14) of the support structure (10, 100) is greatly reduced with respect to the illumination systems of the state of the art, which enables the opening (4) of said support structure (10, 100) to be minimally invasive from the point of view of perception by a user.

The illumination device (6, 7, 8) further comprises magnetic means (70) suitable to interact magnetically with magnetic means (80) present in the support structure (10, 100). Preferably, the magnetic means of the illumination device (6, 7, 8) comprise magnets (70) present in the upper portion of the illumination device (6, 7, 8) while the magnetic means (80) present in the support structure (10, 100) comprise a sheet (70) of metal material, which can be coupled in mortises (45) adjacent to the rear wall (18) of the support structure (10, 100).

Preferably, the functional unit (40) has a plate form and comprises an outer surface (50), preferably of copper oxide (II), CuO, which acts as a conductive element and comprises electrical contacts (82) extending along the longitudinal direction thereof and used to transmit the current and/or regulate the light intensity of illumination means (6, 7, 8).

Said illumination means (6, 7, 8) comprise electrical contacts (65) that can be coupled to the electrical contacts (82) of the functional unit (40) to keep the illumination device (6, 7, 8) connected to the functional unit (40), wherein the electrical contacts (82) of the functional unit are intended to face the electrical contacts (65) of the illumination device (6, 7, 8).

The functional unit (40) further comprises at least one electrical connector (not shown), arranged for example in a profile (84) of insulating material, on the opposite face of the outer surface (50) of the functional unit (40).

Furthermore, the profile (84) of insulating material is arranged in the side groove (43) present in at least one of the two internal side surfaces (16) of the two side walls (14) of the support structure (10, 100), wherein the functional unit (40) is arranged inside said profile (84) of insulating material, and attached to the profile (84) of insulating material by means of attachment means (75), preferably an adhesive. In this way, the outer surface (50) of the functional unit (40) defines the internal space (12) in width, in other words, between the two side walls (14) of the support structure (10, 100) when the illumination device is coupled to the support structure (10, 100).

The electrical connector (not shown) of the functional unit can be connected to a power cable for the electrical connection of several functional units (40) to control means of LED modules,

The illumination system of the present invention further comprises an illumination device (6, 7, 8) able to be magnetically coupled to the functional unit (40) while establishing an electrical connection with the electrical contacts (82) of the functional unit (40) that extend along the longitudinal direction.

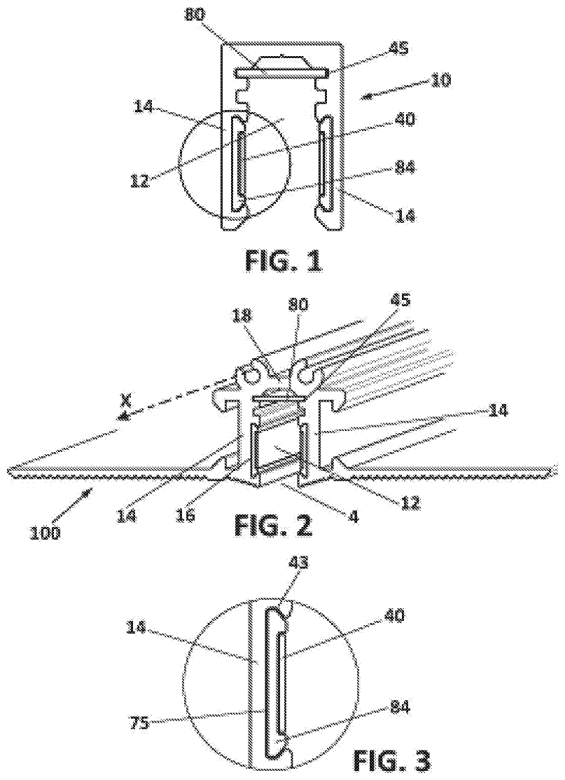

In a first example of support structure (10) shown in FIG. 1, said support structure (10) is arranged flush with the surface of the ceiling, wall or floor.

In a second example of support structure (100) shown in FIG. 2, said support structure (100) is arranged recessed with respect to the surface of the ceiling, wall or floor.

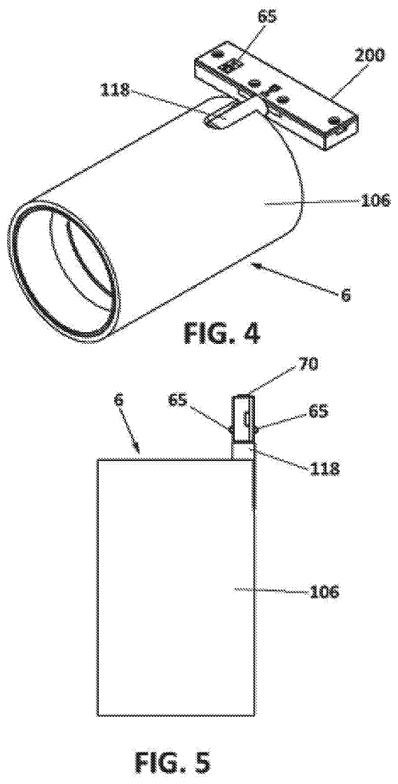

In a first exemplary embodiment shown in FIGS. 4 to 5, the illumination device (6) comprises a casing (200) from which the electrical contacts (65) of the illumination device (6) protrude laterally, wherein the casing (200) is attached to illumination means (106), for example LED modules, for example by means of a telescopic system (118).

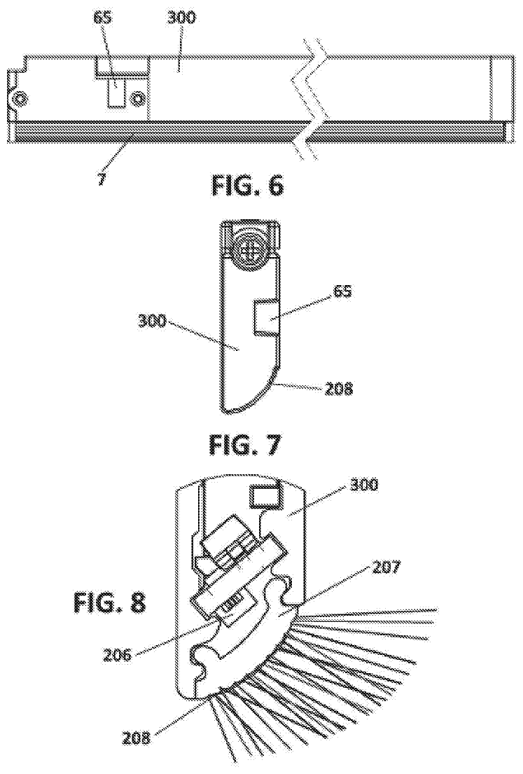

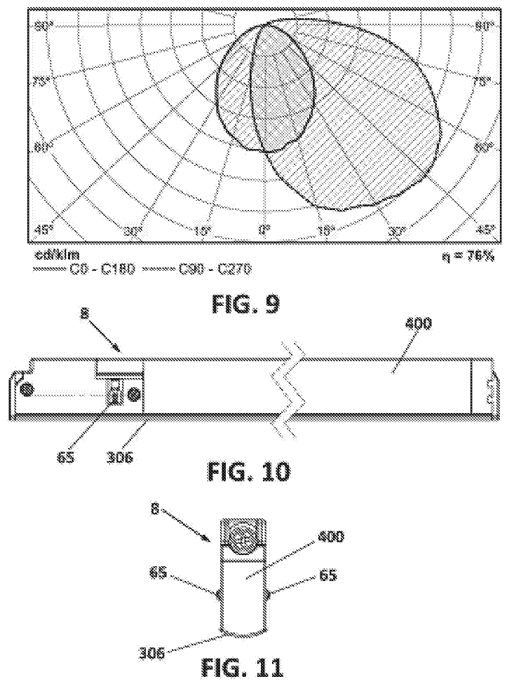

In a second exemplary embodiment shown in FIGS. 6 to 8, the illumination device (7) comprises a casing (300) from which the electrical contacts (65) of the illumination device (7) protrude laterally, wherein the casing (300) comprises illumination means (206) therein, for example LED modules, that pass through a lens (207) comprising an external faceting (208), preferably at an angle of 45° from the vertical, preferably formed by means of extrusion.

In a third exemplary embodiment shown in FIGS. 10 to 11, the illumination device (8) comprises a casing (400) from which the electrical contacts (65) of the illumination device (8) protrude laterally, wherein the casing (400) comprises illumination means (306) therein.

One or more illumination devices (6, 7, 8) of those described above can be inserted into the support structure (10, 100), connecting to the functional unit (40) due to the magnetic coupling between the magnetic means (70) of each illumination device (6, 7, 8) and the magnetic means of the support structure (10, 100), while the electrical contacts (65) of the illumination devices (6, 7, 8) establish an electrical contact with the electrical contacts (82) of the functional unit (40).

The illumination devices (6, 7, 8) can be moved along the longitudinal direction of the functional unit (40), since the electrical contacts (65) of each illumination device (6, 7, 8) are kept in contact with the electrical contacts (82) of the functional unit (40).

Therefore, it is possible to place the illumination devices (6, 7, 8) along the support structure (10, 100) at will.

According to a variant embodiment, for the illumination devices (6) provided with a telescopic system (118), it is also possible to arrange illumination means (106) outside of the internal space (12) of the support structure (10, 100) once the illumination device (6) has been coupled to the support structure (10, 100).

1. An illumination system for walls, ceilings or floors comprising:
a support structure (10, 100) extending in a longitudinal direction and forming an internal space (12) accessible from an opening (4) of said support structure (10, 100), wherein the support structure comprises two facing side walls (14) and a rear wall (18) connecting the two facing side walls (14) and closing the internal space (12) at the rear portion thereof,
at least one functional unit (40) extending in the longitudinal direction which can be housed in the internal space (12) of the support structure (10, 100), wherein the functional unit (40) comprises at least one electrical contact (82);
at least one illumination device (6, 7, 8) provided with illumination means (106, 206, 306) and comprising electrical contacts that can be coupled to the at least one electrical contact (82) of the functional unit (40) to keep the illumination device (6, 7, 8) connected to the functional unit (40),
characterised in that the at least one electrical contact (82) of the functional unit (40) is integrated in at least one of the two side walls (14) of the support structure (10, 100) and it is intended to face the electrical contacts (65) of the illumination device (6, 7, 8).

2. The illumination system according to claim 1, characterised in that the at least one functional unit (40) comprises a plate of conductive material, preferably Cu, comprising an outer surface wherein the at least one electrical contact (82) is arranged in the form of a darkened conductive coating, preferably copper oxide (II), CuO.

3. The illumination system according to any of the preceding claims, characterised in that the at least one functional unit (40) comprising the at least one electrical contact (82) is attached to the support structure (10, 100) by means of attachment means (75), preferably an adhesive.

4. The illumination system according to claim 3, characterised in that it further comprises insulation means (84) arranged between the support structure (10, 100) and the at least one functional unit (40) comprising the at least one electrical contact (82).

5. The illumination system according to claim 4, characterised in that the insulation means (84) comprise a profile of insulating material, arranged on the opposite face of an outer surface (50) of the functional unit (40), outer surface (50) comprising the at least one electrical contact (82) of the at least one functional unit (40).

6. The illumination system according to any of the preceding claims, characterised in that the functional unit (40) is integrated in at least one of the two side walls (146) of the support structure (10, 100).

7. The illumination system according to claim 6, characterised in that the at least one functional unit (40) can be coupled in at least one side groove (43) present in at least one of two internal side surfaces (16) of the two side walls (14) of the support structure (10, 100).

8. The illumination system according to claims 5 and 7, characterised in that the profile (84) of insulating material is arranged in the side groove (43) present in at least one of the two internal side surfaces (16) of the two side walls (14) of the support structure (10, 100), wherein the functional unit (40) is arranged inside said profile (84) of insulating material, and attached to the profile (84) of insulating material by means of attachment means (75).

9. The illumination system according to any of the preceding claims, characterised in that the illumination device (6, 7, 8) further comprises magnetic means (70) suitable to interact magnetically with magnetic means (80) present in the support structure (10, 100).

10. The illumination system according to claim 9, characterised in that the magnetic means of the illumination device (6, 7, 8) comprise magnets (70) present in the upper portion of the illumination device (6, 7, 8) while the magnetic means (80) present in the support structure (10, 100) comprise a sheet (70) of metal material, which can be coupled in mortises (45) adjacent to the rear wall (18) of the support structure (10, 100).

11. The illumination system according to any of the preceding claims, characterised in that the at least one functional unit (40) further comprises at least one electrical connector.

12. The illumination system according to any of the preceding claims, characterised in that the support structure (10) is arranged flush with the surface of the ceiling, wall or floor.

13. The illumination system according to any of claims 1 to 11, characterised in that the support structure (100) is arranged recessed with respect to the surface of the ceiling, wall or floor.

14. The illumination system according to any of the preceding claims, characterised in that the illumination device (6) comprises a casing (200) from which the electrical contacts (65) of the illumination device (6) protrude laterally, wherein the casing (200) is attached to illumination means (106), for example by means of a telescopic system (118).

15. The illumination system according to any of claims 1 to 13, characterised in that the illumination device (7) comprises a casing (300) from which the electrical contacts (65) of the illumination device (7) protrude laterally, wherein the casing (300) comprises illumination means (206) therein that pass through a lens (207) comprising an external faceting (208).

16. The illumination system according to any of claims 1 to 13, characterised in that the illumination device (8) comprises a casing (400) from which the electrical contacts (65) of the illumination device (8) protrude laterally, wherein the casing (400) comprises illumination means (306) therein.

17. The illumination system comprising one or more of the illumination devices (6, 7, 8) of any of claims 14 to 16.

18. The illumination system according to any of claims 14 to 17 characterised in that the illumination device or devices (6, 7, 8) can be moved along the longitudinal direction of the functional unit (40).
